(19) United States
(12) Patent Application Publication
(10) Pub. No.: US 2025/0173776 A1
(43) Pub. Date: May 29, 2025

(54) REQUEST PROCESSING METHOD AND DEVICE

(71) Applicant: Beijing Youzhuju Network Technology Co., Ltd., Beijing (CN)

(72) Inventors: Xun Gan, Beijing (CN); Hui Liu, Beijing (CN); Chen Wang, Beijing (CN)

(21) Appl. No.: 18/842,024

(22) PCT Filed: Feb. 21, 2023
(86) PCT No.: PCT/CN2023/077450

§ 371 Date: Aug. 27, 2024

(30) Foreign Application Priority Data
Feb. 28, 2022 (CN) 202210190744.9

(51) Int. Cl. G06Q 30/0601; H04L 12/66; H04L 67/52

(52) U.S. Cl. CPC G06Q 30/0635; H04L 12/66; H04L 67/52

(57) ABSTRACT

Here provide a request processing method and apparatus, an electronic device, a storage medium, a computer program and a computer program product, which relate to the technical field of computer processing. The method includes: receiving a data processing request for processing an order; determining a target region corresponding to a purchaser of the order; selecting, from predetermined configuration information, a master data center corresponding to the target region as a first data center for processing the data processing request, the predetermined configuration information comprising a respective master data center corresponding to at least one region; sending the data processing request to the first data center for processing.

### CROSS REFERENCE TO RELATED APPLICATIONS

This disclosure claims priority to Chinese Patent Application No. 202210190744.9, filed with the Chinese Patent Office on Feb. 28, 2022, and entitled “REQUEST PROCESSING METHOD AND DEVICE”, which is incorporated herein by reference in its entirety.

### FIELD

Embodiments of the present disclosure relate to the technical field of computer processing, and in particular, to a request processing method and apparatus, an electronic device, a storage medium, a computer program, and a computer program product.

### BACKGROUND

In the era of economic globalization, the purchase of commodity may be cross-regional. A country may be a region, or one or more countries may forma region. For example, users in country A1 may purchase goods from sellers in country A2. These purchase processes form numerous orders that may be stored and managed by a data center. For example, when a data processing request is used for adding an order, the data center may store the newly added order; when the data processing request is used for modifying an order, the data center may modify the assigned order; when the data processing request is used for deleting an order, the data center may delete the assigned order; and when the data processing request is used for reading order data, the data center may return data of the assigned order.

In the prior art, a plurality of data centers can be generally provided, but each region corresponds to a data center responsible for the region, a data processing request from a user in the region is processed by the corresponding data center, and the data center is synchronized to other data centers after being processed. When a data processing request for an order is received, the corresponding data center may modify the data of the order.

However, in the above process, states of the same order may be inconsistent.

### SUMMARY

Embodiments of the present disclosure provide a request processing method and device.

In a first aspect, embodiments of the present disclosure provide a method of request processing implemented at a first gateway. The method comprises:
receiving a data processing request for processing an order;
determining a target region corresponding to a purchaser of the order;
selecting, from predetermined configuration information, a master data center corresponding to the target region as a first data center for processing the data processing request, the predetermined configuration information comprising a respective master data center corresponding to at least one region; sending the data processing request to the first data center for processing.

In a second aspect, embodiments of the present disclosure provide an apparatus for request processing, the apparatus being implemented at a first gateway. The apparatus comprises:
a data processing request receiving module configured to receive a data processing request for processing an order;
a target region determining module configured to determine a target region corresponding to a purchaser of the order;
a data center determination module, configured to select, from predetermined configuration information, a master data center corresponding to a target region as a first data center for processing the data processing request, the predetermined configuration information comprising a master data center corresponding to at least one region; and
a data processing module configured to send the data processing request to the first data center for processing.

In a third aspect, embodiments of the present disclosure provide an electronic device. The electronic device comprises: at least one processor and a memory;
the memory stores computer execution instructions;
the computer execution instructions stored in the memory are executed by the at least one processor to the electronic device to implement the method according to the first aspect.

In a fourth aspect, embodiments of the present disclosure provide a computer readable storage medium. The computer readable storage medium has a computer program stored thereon which, when executed by a processor, implements steps of the method according to the first aspect.

In a fifth aspect, embodiments of the present disclosure provide a computer program. The computer program, when executed by at least one processing unit, implements the method according to the first aspect.

In a sixth aspect, embodiments of the present disclosure provide a computer program product comprising a computer program. The computer program, when executed by at least one processing unit, implements the method according to the first aspect.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description show some embodiments of the present disclosure. Other drawings may also be obtained according to these drawings without creative efforts.

FIG. 1 is a schematic diagram of a data processing scenario to which embodiments of the present disclosure are applicable;

FIG. 2 is a flowchart of steps of a request processing method according to embodiments of the present disclosure;

FIGS. 3 and 4 are schematic diagrams of two processing flowcharts of a data processing request according to embodiments of the present disclosure;

FIGS. 5 and 6 are two schematic diagrams of a gateway of a data center according to embodiments of the present disclosure;

FIG. 7 is a structural block diagram of a request processing apparatus according to embodiments of the present disclosure;

FIG. 8 is a block diagram of an electronic device according to embodiments of the present disclosure.

### DETAILED DESCRIPTION

In order to make objects, technical solutions and advantages of the embodiments of the present disclosure more apparent, the technical solutions in the embodiments of the present disclosure will be described below in a clearly and fully understandable way in connection with the drawings related to the embodiments of the present disclosure. Obviously, the described embodiments are only a part but not all of the embodiments of the present disclosure. All other embodiments obtained by persons of ordinary skill in the art based on the embodiments of the present disclosure without creative efforts shall belong to the scope of protection of the present disclosure.

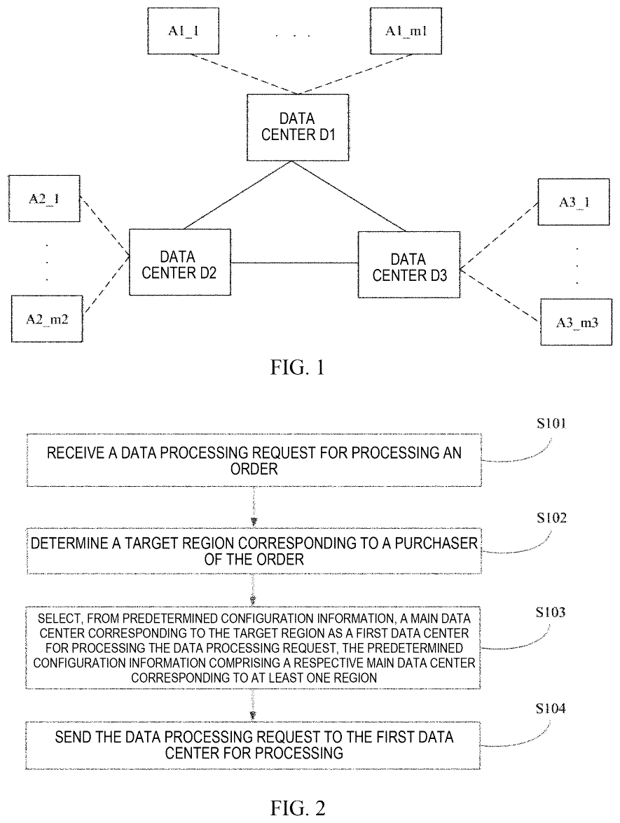

Embodiments of the present disclosure may be applied to a data processing scenario of an order. FIG. 1 is a schematic diagram of a data processing scenario to which embodiments of the present disclosure are applicable. FIG. 1 shows three example data centers D1 to D3. D1, D2 and D3 are communicatively connected to each other, so as to perform data synchronization from a master data center to a slave data center. The data center herein refers to an equipment room for processing and storing data.

Referring to FIG. 1, D1 is used to process data processing requests of m1 regions A11 to A1_m1.

That is, a master data center of the regions A1_1 to A1_m1 is D1. D2 and D3 are the slave data centers of the regions A1_1 to A1_m1. After D1 processes the data processing requests from the users in the regions A1_1 to A1_m1, the data may be synchronized to D2 and D3.

D2 is used for processing data processing requests of m2 regions A2_1 to A2_m2, that is to say, a master data center of A2_1 to A2_m2 is D2, and D1 and D3 are slave data centers of the regions A2_1 to A2_m2. After D2 processes the data processing requests from the users in the regions A2_1 to A2_m2, the data may be synchronized to D1 and D3.

D3 is used for processing data processing requests of m3 regions A3_1 to A3_m3, that is to say, master data centers of A3_1 to A3_m3 are D3, and D1 and D2 are slave data centers of the regions A3_1 to A3_m3. After D3 processes the data processing requests of the users in the regions A3_1 to A3_m3, the data may be synchronized to D1 and D2.

As shown in FIG. 1, one region corresponds to only one master data center and a plurality of slave data centers, but one master data center may correspond to one or more regions, and one slave data center may correspond to one or more regions.

In the prior art, when a user initiates a data processing request, the data processing request is processed by a master data center of a region corresponding to the user, and the master data center synchronizes the data processing request to a slave data center after processing. The user may be a purchaser or a seller. For example, if a purchaser U1 is in the region A1_1, the data processing request for the order initiated by the purchaser U1 is processed by the master data center D1 in the region A11. As another example, if a seller U2 is in region A2_1, the data processing request for the order initiated by the seller U2 is processed by the master data center D2 in the region A2_1.

It can be seen that, in the above process, when the purchaser and the seller correspond to different regions and different regions correspond to different master data centers, data processing requests of the same order initiated by the purchaser and the seller are processed by different master data centers, which may cause inconsistencies in the status of the same order.

For example, the purchaser U1 of the region A1_1 wants to cancel the order after purchasing a commodity, and at this time, the master data center D1 of the region A1_1 changes the state of the order to cancel. However, the seller U2 of this commodity is in the region A2_1 and U2 ships the order, and at this time, the master data center D2 corresponding to the region A2_1 changes the state of the order to be delivered. In this way, the states of the same order in D1 and D2 are inconsistent.

In order to solve the described technical problem, in the embodiments of the present disclosure, whether a purchaser initiates a data processing request for an order or a seller initiates a data processing request for an order, a master data center of a target region corresponding to the purchaser processes the data processing request. In this way, for the same order, both a purchaser and a seller modify data of the same data processing center, thereby preventing the purchaser and the seller from modifying data from different data centers, and preventing inconsistency between data of the two data centers.

For example, the purchaser U1 in the region A1_1 wants to cancel the order after purchasing a commodity, and in this case, D1 changes the state of the order to cancel. In the embodiment of the present disclosure, the data processing request for the order is processed by the master data center of the region corresponding to the purchaser, so that when the seller U2 ships the order, the master data center D1 corresponding to the region A1_1 changes the state of the order to be delivered. In this way, there is only one state for the same order, and there is no inconsistent state.

The technical solutions of the embodiments of the present disclosure and how to solve the above technical problem by the technical solutions of the present disclosure will be described in detail below with reference to specific embodiments. The following several specific embodiments may be combined with each other, and the same or similar concepts or procedures may not be repeated in certain embodiments. Embodiments of the present disclosure will be described below with reference to the accompanying drawings.

FIG. 2 is a flowchart of steps of a request processing method according to embodiments of the present disclosure. The method shown in FIG. 2 may be applied in a first gateway, and the first gateway is configured to schedule and forward a data processing request. The first gateway may be an independent device, and may also be a virtual module integrated in other devices. Referring to FIG. 2, the request processing method includes:

S101: receiving a data processing request for processing an order.

The data processing request may be initiated by a purchaser, a seller, or any other third party, which is not limited in the embodiments of the present disclosure.

In addition, data processing requests may be divided into two types: data write request and data read request, where a data write request is used to add data, delete data, or modify data. A data read request is used to read data from the data center, and does not modify, delete, or add the data in the data center.

For example, when the purchaser needs to initiate an order, the data processing request may be a data write request for writing data of the newly generated order to the data center.

For another example, when the purchaser needs to cancel the order or the seller needs to ship the order, the data processing request may be a data write request for modifying the status of the order in the data center.

As another example, when order data needs to be cleared, the data processing request may be a data write request to delete data for an assigned order in the data center.

When a purchaser or a seller needs to query an order, the data processing request may be a data read request, which is used to obtain data related to the order from a data center.

It should be noted that the purchaser or the seller may initiate the data processing request through an electronic device used by the purchaser or the seller. Specifically, the data processing request may be initiated in an application program or a web page executed on the electronic device.

S102: determining a target region corresponding to a purchaser of the order.

The target region may be any of the following regions: a region where the purchaser is currently located, and a home region where the purchaser is registered. In practical applications, the target region may be set as the region where the purchaser is currently located or the home region registered by the purchaser according to certain requirements. Here, the region is a geographically divided region.

The target region may be determined according to information carried in the data processing request, where the data processing request may include at least one of the following information: the target region, domain name information of a device that submits the data processing request, and identity information of a purchaser. In embodiments of the present disclosure, the data for all orders is divided into sub-datasets according to the region of the purchaser of the order. A sub-data set of a region corresponds to a master data center, and the master data center has a unique permission to write in the region. At the same time, a region corresponds to only one master data center.

However, a master data center may correspond to a subset of one or more regions, the subset of the regions of the master data centers forms the data set of the master data center. It can be understood that data sets of other data centers and data sets of the master data center are the same, and are all data of all orders.

In an example of the embodiments of the present disclosure, when a device needs to send a data processing request, the device may determine a target region, add the target region to the data processing request, and send the data processing request. The target region can be determined by the device according to the following information: SIM (subscriber identity module) information on the device, IP (internet protocol) address of the device and the system region of the device.

Specifically, when the target region is determined according to the SIM information, the region to which the SIM card belongs may be determined as the target region. For example, if the region is a country, an MCC (mobile country code) of the SIM card may be the target region.

When the target region is determined according to the IP address, the region to which the IP address belongs may be determined as the target region.

When the target region is determined according to the system region of the device, the system region of the device may be determined as the target region. The system region of the device may be a region set by a user when the device is used for the first time.

In a practical application, the above three methods for determining a target region may correspond to priorities, so that one of the methods may be selected according to the priorities to determine the target region. For example, the target region is determined according to the following priorities from high to low: determining the target region through the SIM information, determining the target region according to the IP address, and determining the target region according to the system region of the device.

Of course, the described priorities can be flexibly adjusted according to practical application scenarios, and the embodiments of the present disclosure are not limited thereto.

In another example of the embodiments of the present disclosure, the device that initiates the data processing request does not determine the target region, that is to say, the data processing request does not carry the target region, so that when the first gateway receives the data processing request, the target region needs to be determined. In this case, the first gateway may determine the target region according to the domain name information. Specifically, the domain name information is parsed to obtain the target region corresponding to the purchaser of the order.

In an actual application, a piece of domain name information corresponds to a region, and different pieces of domain name information corresponding to different regions are different. When a purchaser initiates a data processing request, domain name information about a device of the purchaser represents a region where the purchaser is currently located, and the region where the purchaser is currently located may be a target region. Since the relationship between the domain name information and the region is fixed, the accuracy of the target region determined according to the domain name information is high.

It should be noted that the region corresponding to the domain name information is a region where the user is currently located when initiating the data processing request, so that the region may be a region where the purchaser is currently located, and may also be a region where the seller is currently located. If the data processing requests are processed by the data centers in the region where the sellers are located, as disclosed in the prior art, the data processing requests of the sellers and the purchaser are processed by two data centers, respectively, and thus the problem of inconsistent orders also exists.

In order to further avoid the described problem, before parsing the domain name information, it also needs to determine whether the data processing request is initiated by the purchaser, and if it is initiated by the purchaser, the region obtained by parsing domain name may be determined as the target region. If the target region is initiated by the seller, the target region needs to be determined by other methods later. In this way, the region where the seller is currently located can be prevented from being determined as the target region, which helps improve the accuracy of the target region, and prevents the data processing request from being processed by the data center of the region where the seller is located, and further ensures the status consistency of the order.

In another example of the embodiments of the present disclosure, the device that initiates the data processing request does not determine the target region, that is to say, the data processing request does not carry the target region, so that when the first gateway receives the data processing request, the target region needs to be determined. In this case, the first gateway may also determine the target region according to identity information, where the identity information is a unique identity used to represent a purchaser. When registering information, a purchaser usually registers a home region corresponding to the purchaser. The identity information herein may be a character string and corresponds to the purchaser on a one-to-one basis. Thus, after generating unique identity information for the purchaser, the data center may record correspondence between the identity information and the home region as registration information. Thus, in the embodiment of the present disclosure, the target region may be determined according to the identity information and the registration information of the purchaser in the data processing request.

Specifically, a region corresponding to the identity information in the data processing request is obtained from the registration information as a target region corresponding to the purchaser of the order, and the registration information includes a home region where the identity information of at least one purchaser is registered. For example, if the home region where a purchaser registers at the time of registration is region A11, the target region of the data processing request for the order of the purchaser is A11, and thus the data processing request may be processed by the master data center D1 of A1_1. Likewise, the region determined according to the identity information of the purchaser must be a home region of the purchaser and may not be a seller region, so that it is unnecessary to determine who is the initiator of the data processing request, and the accuracy of the target region may also be ensured, thereby ensuring the consistency of the status of the order. S103: selecting, from predetermined configuration information, a master data center corresponding to the target region as a first data center for processing the data processing request, the predetermined configuration information comprising a respective master data center corresponding to at least one region.

The predetermined configuration information is pre-configured, and a format of the predetermined configuration information may be flexibly set, as long as the correspondence between a region and a master data center can be represented.

For example, for the three data centers shown in FIG. 1, a first type of format of the predetermined configuration information may be: {D1: A1_1, . . . , A1_m1}, {D2: A2_1, . . . , A2_m2}, and {D3: A3_1, . . . , A3_m3}.

For another example, a second type of format of the predetermined configuration information may be: {A1, D1}, {A1_m1, D2}, {A2_1, D2}, {A2_m2, D2}, {A31, D3}, {A3_m3, D3}. The format of the configuration information is not limited in the embodiments of the present disclosure.

It can be seen that the region indicated in the second type of format and the master data center have a one-to-one correlation, so that the region may be used as an index, and the master data center may be determined according to the region, thereby helping improve the search efficiency, and further improving a acquisition speed of determining the first data center.

Based on the configuration information, when the target region determined in S102 is A3-1, the first data center determined from the configuration information is D3.

Certainly, the configuration information may be modified. For example, when the data center D1 is abnormal, the master data center corresponding to the regions A1_1 to A1_m1 needs to be modified as the data center D2 or D3, and D1 is modified as the slave data center, where the modification may be achieved by modifying the foregoing configuration information. In the following description, configuration information in the first type of format is used as an example. When the master data center corresponding to the regions A1_1 to A1_m1 is modified to D2, the modified configuration information may be: {D2: A11, . . . , A1_m1, A2_1, . . . , A2_m2} and {D3: A31, . . . , A3_m3}.

In addition to the foregoing scenario of modifying the configuration information, there are other scenarios where the configuration information needs to be modified. In the process of modifying the configuration information, if the data is written into the master data center before modification according to the data processing request, after modification, the data may be lost or may conflict with data in a new master data center.

In order to avoid these problems, in the embodiments of the present disclosure, in the process of modifying the predetermined configuration information, the processing of data processing request of the region may be stopped, where the data processing request of the region is being modified and corresponds to the master data center in the predetermined configuration information. After the configuration information is modified, the data processing request of the region continues to be processed.

Specifically, when receiving a data processing request, a first gateway first determines a target region of the data processing request, and then determines a first data center of the target region. If the first data center is a master data center that is being modified in predetermined configuration information, the first gateway does not send the data processing request to the first data center for processing.

Of course, in order to improve the interaction friendliness, the first gateway may also return an instruction message to the initiator that initiates the data processing request, so as to inform that the data processing request cannot be processed temporarily.

As can be seen from the foregoing description of S101, the data processing request may be divided into a data writing request and a data reading request. Embodiments of the present disclosure determine the data centers that process data write requests and data read requests according to different policies.

When the data processing request is a data write request, the data write request needs to be processed by the master data center, and is synchronized to the slave data centers, so as to ensure that data in each data center is consistent. That is to say, the first gateway may select, from the predetermined configuration information, the master data center corresponding to the target region as the first data center for processing the data writing request, so as to process the data write request through the first data center.

It should be understood that, if the data write request is not processed by the master data center according to the embodiments of the present disclosure, but processed by the slave data center, data of the master data center is inconsistent with data of the slave data center because the written data cannot be synchronized to the master data center.

When the data processing request is a data read request, processing of the data read request by the slave data center may be considered, so that all requests are prevented from being processed by the master data center, which helps to reduce the load of the master data center. In addition, abnormality of the master data center due to large compliance is avoided, and normal of the master data center may be guaranteed so as to process the data write request, thereby helping to improve the success probability and processing efficiency of the master data center for processing the data write request.

Further, the data read request may carry a real-time identification for indicating a real-time requirement of the data read request. Thus, the first gateway may determine a data center that processed the data read request according to the real-time identification. Since the master data center is a data center for processing a data write request, data in the master data center is latest data, i. e. data with high real-time performance. Thus, the data read requests with higher real-time requirements may be processed by the master data center, and the data read requests with lower real-time requirements may be processed by the slave data center.

Specifically, when the real-time performance identification carried by the data read request is the first identification, it indicates that the data read request has a high real-time requirement; therefore, the first gateway may select, from the predetermined configuration information, the master data center corresponding to the target region as the first data center for processing the data read request, so as to process the data read request through the first data center. In this way, a high real-time requirement of the data read request may be ensured. For example, since obtaining the state of the order is generally to obtain the latest state, the data read request for reading the state of the order has a high real-time requirement, and may carry the first identification, so that the data read request for reading the state of the order may be processed by the master data center.

When the real-time identification carried by the data read request is the second identification, it indicates that the data read request has a low real-time requirement, so that the first gateway may process the data read request through the second data center, where the second data center is a data center other than the first data center in the target region. For example, because the change of commodity information of an order is relatively small, a data read request used to read commodity information of the order has a relatively low real-time requirement, and may carry a second identification, so that the data read request used to read commodity information of the order may be processed by a data center.

It can be understood that since the first data center is the master data center corresponding to the target region, the second data center is the slave data center corresponding to the target region. According to the embodiments of the present disclosure, a data read request having a lower real-time requirement may be processed by a data center, so that load of a master data center may be further reduced on a basis of satisfying the lower real-time requirement. In addition, abnormality of the master data center due to large compliance is avoided, and normal of the master data center can be guaranteed so as to process the data write request, thereby helping to improve the success probability and processing efficiency of the master data center for processing the data write request.

S104: sending the data processing request to the first data center for processing.

In the embodiments of the present disclosure, the steps S101 to S104 may be executed by a first gateway, where the first gateway may be a gateway corresponding to any data center. The gateway of each data center in the embodiments of the present disclosure may implement receiving and forwarding of the data processing request in the embodiments of the present disclosure, that is, any gateway may perform the processes of S101 to S104.

Compared with a scenario in which only one gateway performs receiving and forwarding, in the embodiments of the present disclosure, when one gateway is abnormal, the other gateways may also receive and forward the data processing request, which helps to improve the success probability of processing the data processing request, and avoids that all gateways are unavailable due to abnormality of one gateway. In addition, each data center has a gateway, so that a processing load of each gateway can be balanced, an abnormality of the gateway caused by a relatively large processing compliance of the gateway is avoided, and a processing success probability of a data processing request is further improved.

In the embodiments of the present disclosure, the first data center may be a data center corresponding to the first gateway, or may be data centers corresponding to other gateways.

If the first data center is a data center corresponding to the first gateway, the data processing request is sent to a first server for processing, where the first server is a server of the first data center.

If the first data center is not a data center corresponding to the first gateway, the data processing request is sent to a second server for processing via a second gateway, where the second gateway is a server of the first data center, and the second server being a server of the first data center.

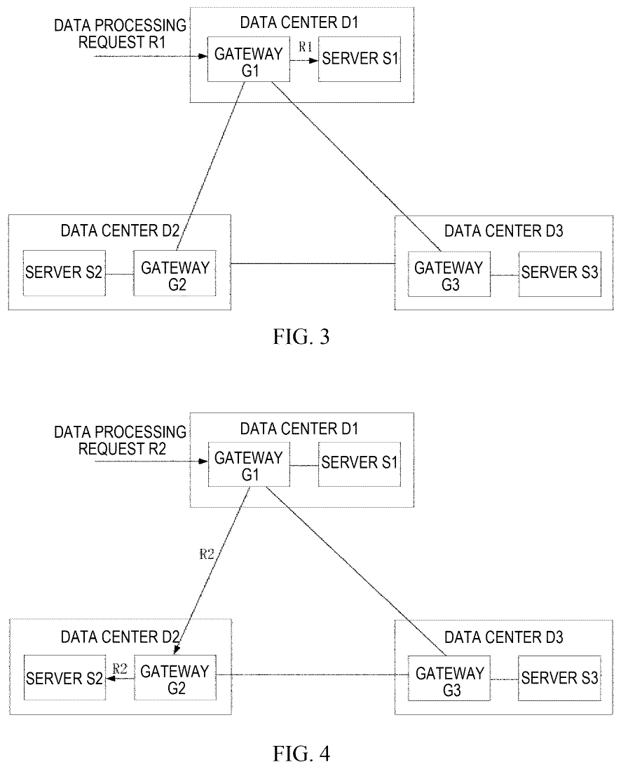

FIGS. 3 and 4 are schematic diagrams of two processing flowcharts of a data processing request according to embodiments of the present disclosure. Referring to FIG. 3, a data center D1 corresponds to a server S1 and a gateway G1, a data center D2 corresponds to a server S2 and a gateway G2, and a data center D3 corresponds to a server S3 and a gateway G3.

Referring to FIG. 3, when a gateway G1 receives a data processing request R1, G1 is a first gateway, and if G1 determines that a first data center of R1 is D1, a server S1 of D1 is the first server. Thus, G1 may send R1 to S1 for processing.

Referring to FIG. 4, when a gateway G1 receives a data processing request R2, G1 is a first gateway, and if G1 determines that the first data center of R2 is D2, a server S2 of D2 is a second server. Thus, G1 may send R2 to G2, and G2 sends R2 to S2 for processing.

By the same reasoning, when the data center D2 or D3 receives a data processing request, the data center D2 or D3 is a first gateway, and the first data center is determined according to the described process, so as to forward the data processing request according to whether the first data center is a data center corresponding to the first gateway. The forwarding process is similar to the process shown in FIGS. 3 and 4, and will not be repeated in the embodiments of the present disclosure.

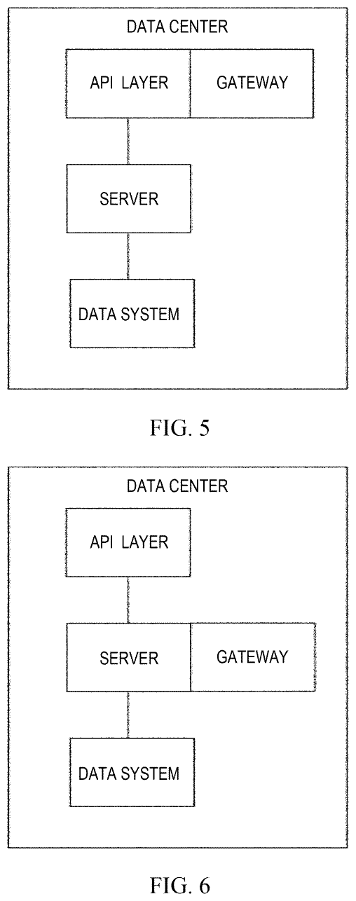

FIGS. 5 and 6 are two schematic diagrams of a gateway of a data center according to embodiments of the present disclosure. Referring to FIG. 5, a data center is provided with an application programming interface (Application Programming Interface, API) layer, a server and a data system.

The application programming interface layer is used for receiving a data processing request and forwarding same to a server, and the server is used for processing data in a data system according to the data processing request, and the data system may be understood as a database.

Referring to FIG. 5, the gateway may be an API in an API layer of a data center. Referring to FIG. 6, the gateway may also be a service loaded on a server.

When the gateway is a service loaded on the server, if the first data center is a data center corresponding to the first gateway, the first gateway is a service loaded on a server of the first data center and is referred to as a first service. Thus, the process of sending, by the first gateway, the data processing request to the first server for processing may be sending, by the first service, the data processing request to the first server corresponding to the first service, and the first gateway and the first server both belong to the first data center.

When the gateway is a service loaded on the server, if the first data center is not a data center corresponding to the first gateway, in this case, the first gateway is a service loaded on a server of a second data center, the second gateway is a service loaded on a server of the first data center, and the second data center is a data center other than the first data center. Thus, the process of sending, by the first gateway, the data processing request to the second server for processing through the second gateway may be sending, by the first service, the data processing request to the second service, and sending, by the second service, the data processing request to the second server corresponding to the second service for processing. The second gateway and the second server both belong to a first data center.

When the gateway is an API in the API layer of the data center, if the first data center is a data center corresponding to the first gateway, the first gateway is an API in an application programming interface API layer of the first data center, and is referred to as a first API. Thus, the process of sending, by the first gateway, the data processing request to the first server for processing may be sending, by the first API, the data processing request to the first server corresponding to the first API for processing, and the first gateway and the first server both belong to the first data center.

When the gateway is an API in the API layer of the data center, if the first data center is not the data center corresponding to the first gateway, the first gateway is an API in an API layer of a second data center, the second gateway is an API in an API layer of the first data center, and the second data center is a data center other than the first data center. Thus, the process of sending, by the first gateway, the data processing request to the second server for processing through the second gateway may be sending, by the first API, the data processing request to the second API, and sending, by the second API, the data processing request to the second server corresponding to the second API for processing. The second gateway and the second server both belong to a first data center.

It may be understood that a gateway may be provided at both the API layer and the server, so that when the API layer may determine the target region, the first data center may be determined, and the data processing request may be sent to the first data center through the API. If the API layer may not determine the target region, because the first data center may not be determined, the API needs to first send the data processing request to the server corresponding to the API layer, so that the server determines the target region and the first data center, and sends the data processing request to the second gateway of the second server, and the second gateway sends the data processing request to the first data center. In this way, in the embodiments of the present disclosure, the data processing request may be forwarded in various manners, which helps to improve the success probability of forwarding the data processing request and further improve the success ratio of processing the data processing request.

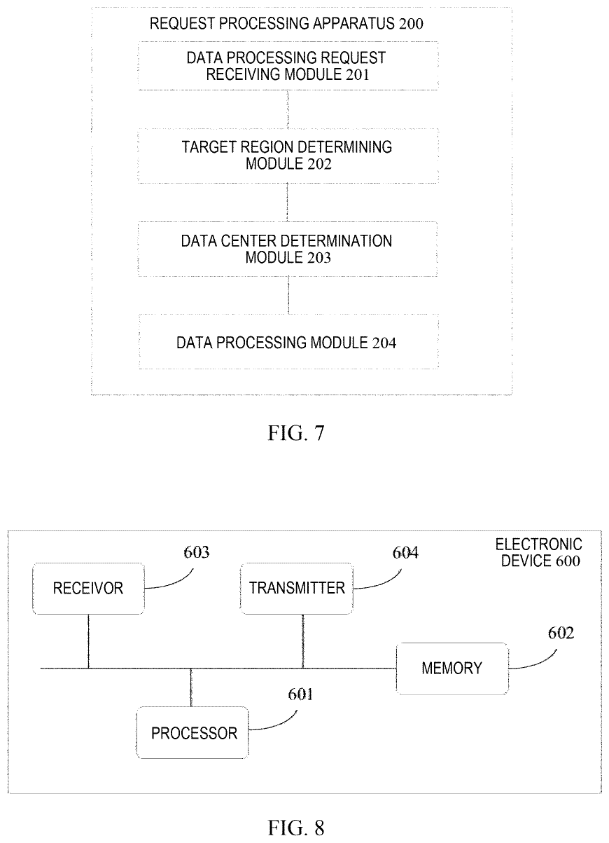

Corresponding to the request processing method in the above embodiments, FIG. 7 is a block diagram of a request processing apparatus according to embodiments of the present disclosure, which is applied to a first gateway. For ease of description, only parts related to the embodiments of the present disclosure are shown. Referring to FIG. 7, the request processing apparatus 200 includes a data processing request receiving module 201, a target region determining module 202, a data center determining module 203, and a data processing module 204.

The data processing request receiving module 201 is configured to receive a data processing request for processing an order.

The target region determining module 202 is configured to determine a target region corresponding to a purchaser of the order.

The data center determining module 203 is configured to select, from predetermined configuration information, a master data center corresponding to a target region as a first data center for processing the data processing request, the predetermined configuration information comprising a master data center corresponding to at least one region.

The data processing module 204 is configured to send the data processing request to the first data center for processing.

Optionally, the data processing module 204 is further configured to:
when sending the data processing request to the first data center for processing, if the first data center is a data center corresponding to the first gateway, send the data processing request to a first server for processing, the first server being a server of the first data center.

If the first data center is not a data center corresponding to the first gateway, the data processing request is sent to a second server for processing via a second gateway, the second gateway being a server of the first data center, and the second server being a server of the first data center.

Optionally, if the first data center is a data center corresponding to the first gateway, the first gateway is a service loaded on a server of the first data center.

If the first data center is not a data center corresponding to the first gateway, the first gateway is a service loaded on a server of a second data center, the second gateway is a service loaded on a server of the first data center, and the second data center is a data center other than the first data center.

Optionally, if the first data center is the data center corresponding to the first gateway, the first gateway is an application programming interface (API) in an API layer of the first data center.

If the first data center is not the data center corresponding to the first gateway, the first gateway is an API in an API layer of a second data center, the second gateway is an API in an API layer of the first data center, and the second data center is a data center other than the first data center.

Optionally, the data processing module 204 is further configured to:
if the data processing request is a data write request or is a data read request with a real-time identification carried as a first identification, sending the data processing request to the first data center for processing, the data write request being configured to perform at least one of the following processing on the order: adding data, deleting data, or modifying data.

Optionally, the apparatus further includes:
if the data processing request is the data read request, and the real-time identification carried in the data read request is a second identification, processing the data read request via a second data center that is a data center other than the first data center.

Optionally, the apparatus further includes:
a configuration information modifying module, configured to modify the predetermined configuration information.
a stop processing module, configured to, during the modifying of the predetermined configuration information, cease processing of a data processing request for a region corresponding to a master data center that is being modified in the predetermined configuration information.

Alternatively, the data processing request includes the target region, and the target region determining module 202 is further configured to:
extract the target region from a target field of the data processing request.

Optionally, the data processing request includes domain name information of a device that submits the data processing request, and the target region determining module 202 is further configured to: parse the domain name information to obtain the target region corresponding to the purchaser of the order.

Alternatively, the data processing request includes identity information of the purchaser, and the target region determination module 202 is further configured to:
obtain a region corresponding to the identity information from registration information as the target region corresponding to the purchaser of the order, the registration information comprising a home region where identity information of at least one purchaser is registered.

The request processing apparatus provided in this embodiment may be configured to execute the technical solution of the method embodiment shown in FIG. 2. Implementation principles and technical effects of the request processing apparatus are similar to those of the method embodiment shown in FIG. 2, and are not repeatedly described herein in this embodiment.

FIG. 8 is a structural block diagram of an electronic device 600 according to an embodiment of the present disclosure. The electronic device 600 includes a memory 602 and at least one processor 601.

The memory 602 stores a computer execution instructions.

The at least one processor 601 executes the computer execution instructions stored in the memory 602, to implement the foregoing method in FIG. 2.

In addition, the electronic device can further include a receiver 603 and a transmitter 604, where the receiver 603 is configured to receive information from other apparatuses or devices and forward the information to the processor 601, and the transmitter 604 is configured to send the information to the other apparatuses or devices.

In a first example of a first aspect, an embodiment of the present disclosure provides method of request processing implemented at a first gateway. The method comprises:
receiving a data processing request for processing an order;
determining a target region corresponding to a purchaser of the order;
selecting, from predetermined configuration information, a master data center corresponding to the target region as a first data center for processing the data processing request, the predetermined configuration information comprising a respective master data center corresponding to at least one region;
sending the data processing request to the first data center for processing.

Based on the first example of the first aspect, in a second example of the first aspect, sending the data processing request to the first data center for processing comprises:
if the first data center is a data center corresponding to the first gateway, sending the data processing request to a first server for processing, the first server being a server of the first data center;
if the first data center is not a data center corresponding to the first gateway, sending the data processing request to a second server for processing via a second gateway, the second gateway being a server of the first data center, and the second server being a server of the first data center.

Based on the second example of the first aspect, in a third example of the first aspect, if the first data center is a data center corresponding to the first gateway, the first gateway is a service loaded on a server of the first data center;
if the first data center is not a data center corresponding to the first gateway, the first gateway is a service loaded on a server of a second data center, the second gateway is a service loaded on a server of the first data center, and the second data center is a data center other than the first data center.

Based on the second example of the first aspect, in a fourth example of the first aspect, if the first data center is the data center corresponding to the first gateway, the first gateway is an application programming interface (API) in an API layer of the first data center;
if the first data center is not the data center corresponding to the first gateway, the first gateway is an API in an API layer of a second data center, the second gateway is an API in an API layer of the first data center, and the second data center is a data center other than the first data center.

Based on any of the first example to the fourth example of the first aspect, in a fifth example of the first aspect, sending the data processing request to the first data center for processing comprises:
if the data processing request is a data write request or is a data read request with a real-time identification carried as a first identification, sending the data processing request to the first data center for processing, the data write request being configured to perform at least one of the following processing on the order: adding data, deleting data, or modifying data.

Based on the fifth example of the first aspect, in a sixth example of the first aspect, the method further comprises:
if the data processing request is a data write request or is a data read request with a real-time identification carried as a first identification, sending the data processing request to the first data center for processing, the data write request being configured to perform at least one of the following processing on the order: adding data, deleting data, or modifying data.

Based on any example of the first to the fourth examples of the first aspect, in a seventh example of the first aspect, the method further comprises:
modifying the predetermined configuration information;
during the modifying of the predetermined configuration information, ceasing processing of a data processing request for a region corresponding to a master data center that is being modified in the predetermined configuration information.

Based on any of the first example to the fourth example of the first aspect, in an eighth example of the first aspect, the data processing request comprises the target region, and determining the target region corresponding to a purchaser of the order comprises:
extracting the target region from a target field of the data processing request.

Based on any of the first example to the fourth example of the first aspect, in a ninth example of the first aspect, the data processing request comprises domain name information of a device that submits the data processing request, and determining the target region corresponding to the purchaser of the order comprises:
parsing the domain name information to obtain the target region corresponding to the purchaser of the order.

Based on any of the first example to the fourth example of the first aspect, in a tenth example of the first aspect, the data processing request comprises identity information of the purchaser, and determining the target region corresponding to the purchaser of the order comprises:
obtaining a region corresponding to the identity information from registration information as the target region corresponding to the purchaser of the order, the registration information comprising a home region where identity information of at least one purchaser is registered.

In a first example of a second aspect, a request processing apparatus is provided, the apparatus is implemented at a first gateway, the apparatus comprises:
a data processing request receiving module configured to receive a data processing request for processing an order;
a target region determining module configured to determine a target region corresponding to a purchaser of the order;
a data center determination module, configured to select, from predetermined configuration information, a master data center corresponding to a target region as a first data center for processing the data processing request, the predetermined configuration information comprising a master data center corresponding to at least one region;
and a data processing module configured to send the data processing request to the first data center for processing.

Based on the first example of the second aspect, in a second example of the second aspect, the data processing module is further configured to:
when sending the data processing request to the first data center for processing, if the first data center is a data center corresponding to the first gateway, send the data processing request to a first server for processing, the first server being a server of the first data center;
if the first data center is not a data center corresponding to the first gateway, sending the data processing request to a second server for processing via a second gateway, the second gateway being a server of the first data center, and the second server being a server of the first data center.

In a second example of the second aspect, in a third example of the second aspect, if the first data center is a data center corresponding to the first gateway, the first gateway is a service loaded on a server of the first data center;
if the first data center is not a data center corresponding to the first gateway, the first gateway is a service loaded on a server of a second data center, the second gateway is a service loaded on a server of the first data center, and the second data center is a data center other than the first data center.

Based on the second example of the second aspect, in a fourth example of the second aspect, if the first data center is the data center corresponding to the first gateway, the first gateway is an application programming interface (API) in an API layer of the first data center;
if the first data center is not the data center corresponding to the first gateway, the first gateway is an API in an API layer of a second data center, the second gateway is an API in an API layer of the first data center, and the second data center is a data center other than the first data center.

Based on any of examples 1 to 4 of the second aspect, in a fifth example of the second aspect, the data processing module is further configured to:
if the data processing request is a data write request or is a data read request with a real-time identification carried as a first identification, send the data processing request to the first data center for processing, the data write request being configured to perform at least one of the following processing on the order: adding data, deleting data, or modifying data.

In a fifth example of the second aspect, in a sixth example of the second aspect, the apparatus further comprises:
a second data processing module configured to, if the data processing request is the data read request, and the real-time identification carried in the data read request is a second identification, process the data read request via a second data center that is a data center other than the first data center.

Based on any of examples 1 to 4 of the second aspect, in a seventh example of the second aspect, the apparatus further comprises:
a configuration information modifying module, configured to modify the predetermined configuration information;
a stop processing module, configured to, during the modifying of the predetermined configuration information, cease processing of a data processing request for a region corresponding to a master data center that is being modified in the predetermined configuration information.

Based on any of the first example to the fourth example of the second aspect, in an eighth example of the second aspect, the data processing request comprises the target region, and the target region determining module is further configured to:
extract the target region from a target field of the data processing request.

Based on any of the first example to the fourth example of the second aspect, in a ninth example of the second aspect, the data processing request domain name information of a device that submits the data processing request, and the target region determining module is further configured to:
parse the domain name information to obtain the target region corresponding to the purchaser of the order.

Based on any of the first example to the fourth example of the second aspect, in an eleventh example of the second aspect, the data processing request comprises identity information of the purchaser, and the target region determining module is further configured to:
obtain a region corresponding to the identity information from registration information as the target region corresponding to the purchaser of the order, the registration information comprising a home region where identity information of at least one purchaser is registered.

In a third aspect, according to one or more embodiments of the present disclosure, an electronic device is provided, comprising: at least one processor and a memory;
the memory stores a computer execution instructions;
the computer execution instructions stored in the memory are executed by the at least one processor to the electronic device to implement the method according to any of the first aspect.

In a fourth aspect, a computer readable storage medium is provided according to one or more embodiments of the present disclosure. The computer readable storage medium has a computer program stored thereon which, when executed by a processor, implements steps of the method according to any of the first aspect.

In a fifth aspect, according to one or more embodiments of the present disclosure, a computer program is provided, where the computer program, when executed by at least one processing unit, implements the method according to any of the first aspect.

The foregoing description is merely illustrative of the preferred embodiments of the present disclosure and of the technical principles applied thereto, as will be appreciated by those skilled in the art, The disclosure of the present disclosure is not limited to the technical solution formed by the specific combination of the described technical features, At the same time, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring that the operations be performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. A method of request processing implemented at a first gateway, the method comprising:
receiving a data processing request for processing an order;
determining a target region corresponding to a purchaser of the order;
selecting, from predetermined configuration information, a master data center corresponding to the target region as a first data center for processing the data processing request, the predetermined configuration information comprising a respective master data center corresponding to at least one region; and
sending the data processing request to the first data center for processing.

2. The method of claim 1, wherein sending the data processing request to the first data center for processing comprises:
if the first data center is a data center corresponding to the first gateway, sending the data processing request to a first server for processing, the first server being a server of the first data center; or
if the first data center is not a data center corresponding to the first gateway, sending the data processing request to a second server for processing via a second gateway, the second gateway being a server of the first data center, and the second server being a server of the first data center.

3. The method of claim 2, wherein,
if the first data center is a data center corresponding to the first gateway, the first gateway is a service loaded on a server of the first data center; or
if the first data center is not a data center corresponding to the first gateway, the first gateway is a service loaded on a server of a second data center, the second gateway is a service loaded on a server of the first data center, and the second data center is a data center other than the first data center.

4. The method of claim 2, wherein,
if the first data center is the data center corresponding to the first gateway, the first gateway is an application programming interface (API) in an API layer of the first data center; or
if the first data center is not the data center corresponding to the first gateway, the first gateway is an API in an API layer of a second data center, the second gateway is an API in an API layer of the first data center, and the second data center is a data center other than the first data center.

5. The method of claim 1, wherein sending the data processing request to the first data center for processing comprises:
if the data processing request is a data write request or is a data read request with a real-time identification carried as a first identification, sending the data processing request to the first data center for processing, the data write request being configured to perform at least one of the following processing on the order: adding data, deleting data, or modifying data.

6. The method of claim 5, wherein the method further comprises:
if the data processing request is the data read request, and the real-time identification carried in the data read request is a second identification, processing the data read request via a second data center that is a data center other than the first data center.

7. The method of claim 1, further comprising:
modifying the predetermined configuration information; and
during the modifying of the predetermined configuration information, ceasing processing of a data processing request for a region corresponding to a master data center that is being modified in the predetermined configuration information.

8. The method of claim 1, wherein the data processing request comprises the target region, and determining the target region corresponding to the purchaser of the order comprises:
extracting the target region from a target field of the data processing request.

9. The method of claim 1, wherein the data processing request comprises domain name information of a device that submits the data processing request, and determining the target region corresponding to the purchaser of the order comprises:
parsing the domain name information to obtain the target region corresponding to the purchaser of the order.

10. The method of claim 1, wherein the data processing request comprises identity information of the purchaser, and determining the target region corresponding to the purchaser of the order comprises:
obtaining a region corresponding to the identity information from registration information as the target region corresponding to the purchaser of the order, the registration information comprising a home region where identity information of at least one purchaser is registered.

11. (canceled)

12. An electronic device, wherein the electronic device comprises: at least one processor and a memory;
the memory stores computer execution instructions;
the computer execution instructions stored in the memory are executed by the at least one processor to cause the electronic device to perform acts comprising:
receiving a data processing request for processing an order;
determining a target region corresponding to a purchaser of the order;
selecting, from predetermined configuration information, a master data center corresponding to the target region as a first data center for processing the data processing request, the predetermined configuration information comprising a respective master data center corresponding to at least one region; and
sending the data processing request to the first data center for processing.

13. A non-transitory computer readable storage medium, wherein the computer readable storage medium has a computer program stored thereon which, when executed by a processor, perform acts comprising:
receiving a data processing request for processing an order;
determining a target region corresponding to a purchaser of the order;
selecting, from predetermined configuration information, a master data center corresponding to the target region as a first data center for processing the data processing request, the predetermined configuration information comprising a respective master data center corresponding to at least one region; and
sending the data processing request to the first data center for processing.

14. (canceled)

15. (canceled)

16. The electronic device of claim 12, wherein sending the data processing request to the first data center for processing comprises:
if the first data center is a data center corresponding to the first gateway, sending the data processing request to a first server for processing, the first server being a server of the first data center; or
if the first data center is not a data center corresponding to the first gateway, sending the data processing request to a second server for processing via a second gateway, the second gateway being a server of the first data center, and the second server being a server of the first data center.

17. The electronic device of claim 16, wherein,
if the first data center is a data center corresponding to the first gateway, the first gateway is a service loaded on a server of the first data center; or
if the first data center is not a data center corresponding to the first gateway, the first gateway is a service loaded on a server of a second data center, the second gateway is a service loaded on a server of the first data center, and the second data center is a data center other than the first data center.

18. The electronic device of claim 16, wherein,
if the first data center is the data center corresponding to the first gateway, the first gateway is an application programming interface (API) in an API layer of the first data center; or
if the first data center is not the data center corresponding to the first gateway, the first gateway is an API in an API layer of a second data center, the second gateway is an API in an API layer of the first data center, and the second data center is a data center other than the first data center.

19. The electronic device of claim 12, wherein sending the data processing request to the first data center for processing comprises:
if the data processing request is a data write request or is a data read request with a real-time identification carried as a first identification, sending the data processing request to the first data center for processing, the data write request being configured to perform at least one of the following processing on the order: adding data, deleting data, or modifying data.

20. The electronic device of claim 19, wherein the acts further comprises:
if the data processing request is the data read request, and the real-time identification carried in the data read request is a second identification, processing the data read request via a second data center that is a data center other than the first data center.

21. The electronic device of claim 12, wherein the acts further comprises:
modifying the predetermined configuration information; and
during the modifying of the predetermined configuration information, ceasing processing of a data processing request for a region corresponding to a master data center that is being modified in the predetermined configuration information.

22. The electronic device of claim 12, wherein the data processing request comprises the target region, and determining the target region corresponding to the purchaser of the order comprises:
extracting the target region from a target field of the data processing request.

23. The electronic device of claim 12, wherein the data processing request comprises domain name information of a device that submits the data processing request, and determining the target region corresponding to the purchaser of the order comprises:
parsing the domain name information to obtain the target region corresponding to the purchaser of the order.
